(19) United States
(12) Patent Application Publication
(10) Pub. No.: US 2024/0219622 A1
(43) Pub. Date: Jul. 4, 2024

(54) ILLUMINATION DEVICE

(71) Applicant: Japan Display Inc., Tokyo (JP)

(72) Inventors: Makoto HASEGAWA, Tokyo (JP); Nobuyuki SUZUKI, Tokyo (JP); Masafumi OKADA, Tokyo (JP)

(21) Appl. No.: 18/604,918

(22) Filed: Mar. 14, 2024

Related U.S. Application Data
(63) Continuation of application No. PCT/JP2022/033735, filed on Sep. 8, 2022.

(30) Foreign Application Priority Data
Sep. 22, 2021 (JP) 2021-154078

(51) Int. Cl. F21V 8/00

(52) U.S. Cl. CPC G02B 6/0053; G02B 6/0076

(57) ABSTRACT

According to one embodiment, an illumination device includes a first projecting portion on a first main surface and a second projecting portion on a second main surface on an opposite side to the first main surface in a first area of a first guide, a third projecting portion on a third main surface opposing the second main surface and a fourth projecting portion on a fourth main surface on an opposite side to the third main surface, in a third area of a second guide, and the first projecting portion and the third projecting portion have a cross sectional shape of a scalene triangle and the second projecting portion and the fourth projecting portion have a cross sectional shape of an isosceles triangle.

### CROSS-REFERENCE TO RELATED APPLICATIONS

This application is a Continuation Application of PCT Application No. PCT/JP2022/033735, filed Sep. 8, 2022 and based upon and claiming the benefit of priority from Japanese Patent Application No. 2021-154078, filed Sep. 22, 2021, the entire contents of all of which are incorporated herein by reference.

### FIELD

Embodiments described herein relate generally to an illumination device.

### BACKGROUND

An illumination device with a light source element and a light guide has been developed as a surface emitting illumination device.

### BRIEF DESCRIPTION OF THE DRAWINGS

FIG. 1 is an exploded perspective view schematically showing a configuration of an illumination device of an embodiment.

FIG. 2 is a cross-sectional view schematically showing the configuration of the illumination device of the embodiment.

FIG. 3 is a cross-sectional view schematically showing an arrangement of a light guide and projecting portions of the illumination device.

FIG. 4A is an enlarged cross-sectional view schematically showing a shape of the projecting portions of the illumination device.

FIG. 4B is an enlarged cross-sectional view schematically showing a shape of the projecting portions of the illumination device.

FIG. 5A is an enlarged cross-sectional view schematically showing a shape of projecting portions of the illumination device.

FIG. 5B is an enlarged cross-sectional view schematically showing a shape of the projecting portions of the illumination device.

FIG. 6 is a perspective view showing a configuration of a liquid crystal lens.

FIG. 7 is an exploded perspective view of the liquid crystal lens shown in FIG. 6.

FIG. 8 is a perspective view schematically showing a first liquid crystal cell shown in FIG. 7.

FIG. 9 is a diagram schematically showing the first liquid crystal cell in an off state (OFF), in which no electric field is formed in a liquid crystal layer.

FIG. 10 is a diagram schematically showing the first liquid crystal cell in an on state (OFF), in which an electric field is formed in the liquid crystal layer.

FIG. 11 is a diagram showing distribution of illumination of light emitted from an illumination element.

FIG. 12 is a diagram showing distribution of illumination of light emitted from the illumination element.

FIG. 13 is a diagram showing the relationship of a normalized luminous intensity of emission light to a zenith angle in the illumination element.

FIG. 14 is a diagram showing the relationship of a normalized luminous intensity of emission light to a zenith angle in the illumination element.

FIG. 15 is a diagram showing the relationship of the luminous intensity of the emission light to the angle of the emission light in the illumination device of the embodiment.

FIG. 16 is a diagram showing the relationship of the luminous intensity of the emission light to the angle of the emission light in the illumination device of the embodiment.

FIG. 17 is a diagram showing the relationship of the luminous intensity of the emission light to the angle of the emission light in the illumination device of the embodiment.

FIG. 18 is a diagram showing the relationship of the luminous intensity of the emission light to the angle of the emission light in the illumination device of the embodiment.

FIG. 19 is a diagram showing the relationship of the luminous intensity of the emission light to the angle of the emission light in the illumination device of the embodiment.

FIG. 20 is a diagram showing the relationship of the luminous intensity of the emission light to the angle of the emission light in the illumination device of the embodiment.

FIG. 21 is a diagram showing the relationship of the luminous intensity of the emission light to the angle of the emission light in the illumination device of the embodiment.

FIG. 22 is a diagram showing the relationship of the luminous intensity of the emission light to the angle of the emission light in the illumination device of the embodiment.

FIG. 23 is a diagram showing the relationship of the luminous intensity of the emission light to the angle of the emission light in the illumination device of the embodiment.

FIG. 24 is a diagram showing an example of an application of the illumination device of the embodiment.

FIG. 25 is a diagram showing an example of an application of the illumination device of the embodiment.

FIG. 26 is a diagram showing an example of an application of the illumination device of the embodiment.

FIG. 27 is a diagram showing an example of an application of the illumination device of the embodiment.

### DETAILED DESCRIPTION

In general, according to one embodiment, an illumination device comprises
a first illumination element comprising a first light source element and a first light guide including a first area and a second area;
a second illumination element overlapping the first illumination element and comprising a second light source element and a second light guide including a third area and a fourth area; and
a liquid crystal cell overlapping the second illumination element, wherein
the first light guide includes a first side surface and a second side surface,
the first light source element is located to oppose the second side surface,
the second area is located between the second side surface of the first light guide and the first area,
the second light guide includes a third side surface and a fourth side surface,
the second light source element is located to oppose the third side surface of the second light guide,
the fourth area is located between the fourth side of the second light guide and the third area, the fourth side surface is disposed closer to the second side surface than the first side surface,
the first area of the first light guide is provided with a first projecting portion on a first main surface and a second projecting portion on a second main surface on a side opposite to the first main surface,
the third area of the second light guide is provided with a third projecting portion on a third main surface on a side opposite to the second main surface and a fourth projecting portion on a fourth main surface on a side opposite to the third main surface,
the liquid crystal cell includes a first substrate provided with a first electrode, a second substrate provided with a second electrode, and a liquid crystal layer provided between the first substrate and the second substrate,
the first projecting portion and the third projecting portion have a cross-sectional shape of a scalene triangle, and
the second projecting portion and the fourth projecting portion have a cross-sectional shape of an isosceles triangle.

An object of this embodiment is to provide an illumination device which can irradiates light at a desired location.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of an illumination device with reference to the drawings.

In this embodiment, a first direction X, a second direction Y and a third direction Z are orthogonal to each other, but may intersect at an angle other than 90 degrees (°). The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the illumination device on a tip side of the arrow in the third direction Z. Here, viewing from this observation position toward the X-Y plane defined by the first direction X and the second direction Y is referred to as plan view. Viewing a cross-section of the illumination device in the X-Z plane defined by the first direction X and the third direction Z or in the Y-Z plane defined by the second direction Y and the third direction Z is referred to as cross-sectional view.

### EMBODIMENTS

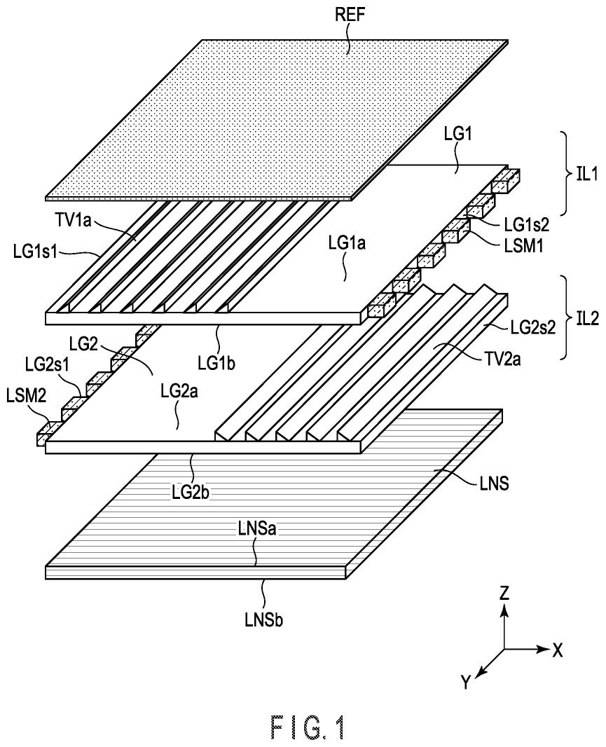

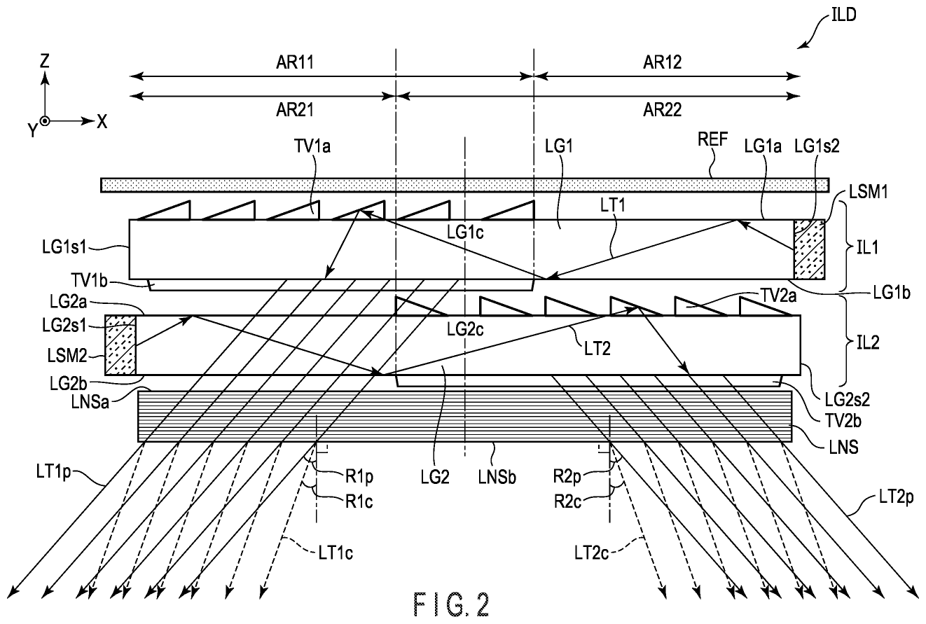

FIG. 1 is an exploded view showing a schematic configuration of an illumination device of this embodiment. FIG. 2 is a cross-sectional view showing the schematic configuration of the illumination device of the embodiment.

An illumination device ILD comprises a reflective sheet REF, an illumination element IL1, an illumination element IL2, and a liquid crystal lens LNS, which are provided in order along a direction opposite to the third direction Z. Light emitted from the illumination device ILD is emitted downward. The reflective sheet REF and the illumination element IL1, the illumination element IL1 and the illumination element IL2, and the illumination element IL2 and the liquid crystal lens LNS are provided to oppose each other, respectively.

The illumination element IL1 comprises a first light guide LG1 and a plurality of first light source elements LSM1. The plurality of light source elements LSM1 are provided adjacent to a second side surface LG1s2 of the light guide LG1. The side surface LG1s2 is a light entry portion where light from the light source elements LSM1 enters. On the first side surface LG1s1, which is on a side opposite to the side surface LG1s2, a light source element LSM1 is not provided.

The light guide LG1 comprises a first main surface LG1a opposing the reflective sheet REF and a second main surface LG1b opposing the light guide LG2. The main surface LG1b is provided on a side opposite to the main surface LG1a. The light guide LG1 includes a central portion LG1c in a side parallel to the first direction X. Note that the central portion LG1c may not be the central part of the parallel sides of the light guide LG1, but may be the central part of the sides of the effective light emitting area in the light guide LG1. The effective light-emitting area is an area where light is emitted from the light guide LG1. This is also the case for the light guide LG2.

Here, the area of the light guide LG1 proximate to the side surface LG1s1 is designated as a first area AR11 and the area of the light guide LG1 proximate to the side surface LG1s2 is designated as a second area AR12. In the area AR11, a plurality of first projecting portions TV1a are provided on the main surface LG1a and a plurality of second projecting portions TV1b are provided on the main surface LG1b. In the area AR12, the projecting portions TV1a and TV1b are not provided. That is, the projecting portions TV1a and the projecting portions TV1b are not provided on a side surface LG1s2 side, where the light source elements LSM1 are provided, but they are provided on a side surface LG1s1 side, where the light source elements LSM1 are not provided.

The area AR11 extends from the side surface LG1s1 beyond the central portion LG1c to the side surface LG1s2. The area AR12 occupies the area from the side surface LG1s2 to just front of the central portion LG1c. In other words, the area AR11 includes the central portion LG1c and the area AR12 does not include the central portion LG1c.

The plurality of projecting portions TV1a are arranged along a direction parallel to the first direction X and each extends along a direction parallel to the second direction Y. The plurality of projecting portions TV1b each extend in a direction parallel to the first direction X and are arranged along a direction parallel to the second direction Y. Each of the projecting portions TV1a has a triangular prism form, the cross-sectional shape of which is a scalene triangle. Each of the projecting portions TV1b has a triangular prism form, the cross-sectional shape of which is an isosceles triangle. Details of the cross-sectional shapes of the projecting portions TV1a and the projecting portions TV1b will be provided later. The projecting portions TV1a and the projecting portions TV1b are formed to be integrated with the light guide LG1 as one body.

The illumination element IL2 comprises a second light guide LG2 and a plurality of second light source elements LSM2. The plurality of light source elements LSM2 are provided adjacent to the third side surface LG2s1 of the light guide LG2. The side surface LG2s1 is the light entry portion where light from the light source elements LSM2 enters. The light source elements LSM2 are not provided on the fourth side surface LG2s2, which is located on a side opposite to the side surface LG2s1.

In FIGS. 1 and 2, the side surface LG2s2 is arranged along the side surface LG1s2 in the third direction Z. Note that the configuration is not limited to this, but it suffices if the side surface LG2s2 is disposed closer to the side surface LG1s2 than to the side surface LG1s1.

The light guide LG2 comprises a third main surface LG2a opposing the light guide LG1 and a fourth main surface LG2b opposing the liquid crystal lens LNS. The main surface LG2b is provided on a side opposite to the main surface LG2a. In the side of the light guide LG2, parallel to the first direction X, the central portion is designated as LG2c.

The area of the light guide LG2, proximate to the side surface LG2s1 is designated as a third area AR21 and the area of the light guide LG2, proximate to the side surface LG2s2 is designated as a fourth area AR22. In the area AR22, a plurality of third projecting portions TV2a are provided on the main surface LG2a and a plurality of fourth projecting portions TV2b are provided on the main surface LG2b. In the area AR21, the projecting portions TV2a and the projecting portions TV2b are not provided. In other words, the projecting portions TV2a and the projecting portions TV2b are not provided on the side surface LG2s1 side, where the light source elements LSM2 are provided, but they are provided on the side surface LG2s2 side, where the light source elements LSM2 are not provided.

The area AR22 extends from the side surface LG2s2 beyond the central portion LG2c to the side surface LG2s1 side. The area AR11 occupies the area from the side surface LG2s1 to just front of the central portion LG2c. In other words, the area AR22 includes the central portion LG2c, whereas the area AR21 does not include the central portion LG2c. Note that the area AR21 and the area AR12 do not overlap each other in plan view.

The plurality of projecting portions TV2a are arranged in a direction parallel to the first direction X and each extends along a direction parallel to the second direction Y. The plurality of projecting portions TV2b each extend in a direction parallel to the first direction X and are arranged along a direction parallel to the second direction Y. Each of the plurality of projecting portions TV2a has a triangular prism form, the cross-sectional shape of which is a scalene triangle. Each of the plurality of projecting portions TV2b has a triangular prism form, the cross-sectional shape of which is an isosceles triangle. Details of the cross-sectional shapes of the projecting portions TV2a and the projecting portions TV2b will be provided later. The projecting portions TV2a and the projecting portions TV2b are formed to be integrated with the light guide LG1 as one body.

In the illumination element IL1, light LT1 emitted from the light source elements LSM1 enters the light guide LG1 from the side surface LG1s2. In the area AR12, where the projecting portions TV1a and the projecting portions TV1b are not provided, the light LT1 is not emitted to the outside and propagates in the light guide LG1 while totally reflecting therein. When the light LT1 reaches the area AR11, the reflection angle is changed by the projecting portions TV1a and the projecting portions TV1b, and the light is emitted toward the illumination element IL2 at an angle with respect to the third direction Z.

The light LT1 entering the illumination element IL2 passes through the light guide LG2, enters the liquid crystal lens from a light incident surface LNSa of the liquid crystal lens and exits from a light exit surface LNSb of the liquid crystal lens.

The light LT1 incident on the liquid crystal lens LNS passes through the liquid crystal lens LNS as it is when the liquid crystal lens LNS is in the off state, and is emitted downward as light LT1p. When the liquid crystal lens LNS is in the on state, the light LT1 is polarized by the liquid crystal lens LNS and is emitted as polarized light LT1c. Details of the configuration and operation of the liquid crystal lens LNS will be provided later.

In the illumination element IL2, light LT2 emitted from the light source element LSM2 enters the light guide LG2 from the side surface LG2s1. In the area AR21, where the projecting portions TV2a and the projecting portions TV2b are not provided, the light LT2 is not emitted to the outside and propagates in the light guide LG2 while totally reflecting therein. When the light LT2 reaches the area AR22, the reflection angle is changed by the projecting portions TV2a and the projecting portions TV2b, and the light is emitted at an angle to the third direction Z toward the liquid crystal lens LNS.

The light LT2 entering the liquid crystal lens LNS passes through the liquid crystal lens LNS as it is and is emitted downward as light LT2p when the liquid crystal lens LNS is in the off state. When the liquid crystal lens LNS is in the on state, the light LT2 is polarized by the liquid crystal lens LNS and is emitted as polarized light LT2c.

The angles at which the light LT1p and the light LT2p are emitted with respect to the third direction Z are designated as an angle Rip and an angle R2p, respectively. When the total of the angles Rip and R2p is referred to as an angle Rp, the angle Rip, then, is the light distribution angle of the light emitted by the illumination device ILD when the liquid crystal lens LNS is in the off state.

Similarly, here, the angles at which the polarized light LT1c and the polarized light LT2c are emitted are designated as an angle R1c and an angle R2c, respectively. When the total angle of the angles R1c and R2c is referred to as an angle Rc, then the angle Rc is the light distribution angle of the light emitted from the illumination device ILD when the liquid crystal lens LNS is in the on state.

The angle Rp (=R1p+R2p) is greater than the angle Rc (=R1c+R2c). Further, the angle Rip and the angle R2p are greater than the angle R1c and the angle R2c, respectively. That is, the light LT1p and the light LT2p are emitted further outward, whereas the polarized light LT1c and the polarized light LT2c are emitted further inward.

The angle Rip and the angle R2p are each, for example, 45°. The angle R1c and the angle R2c are, each, for example, 22°. That is, the angle Rp is 90° and the angle Rc is 44°. Thus, the light distribution angle of the liquid crystal lens LNS in the on state is less than the light distribution angle in the off state.

In the illumination device ILD of this embodiment, the lighting of the light source element LSM1 and the light source element LSM2 of the illumination element IL1 and the illumination element IL2, and the on state and off state of the liquid crystal lens LNS are combined, and thus the illumination light emitted can be controlled to be set in a desired direction.

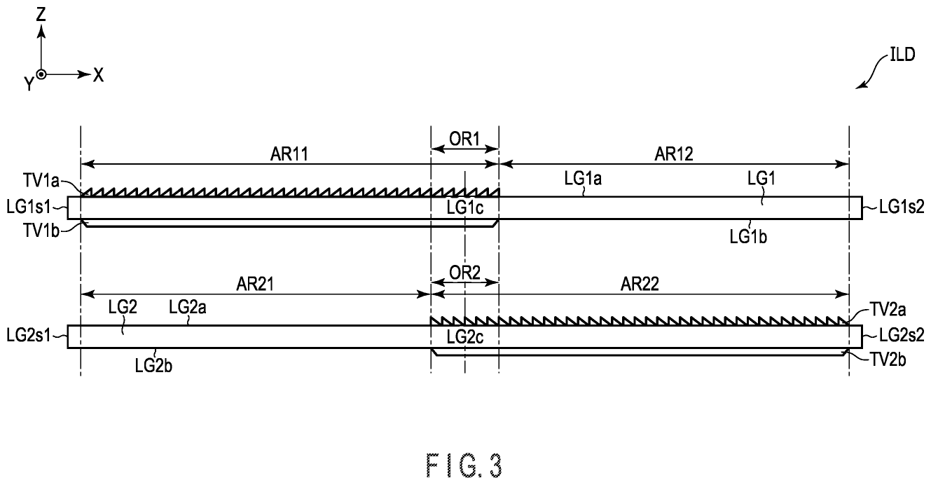

FIG. 3 is a schematic cross-sectional view showing an arrangement of the light guide and the projecting portions of the illumination device. The area AR11 of the light guide LG1 overlaps the area AR22 of the light guide LG2 in plan view. That is, some of the plurality of projecting portions TV1a and some of the plurality of projecting portions TV2a overlap each other in plan view near the central portions of the light guides LG1 and LG2. In reverse, the area AR12 and the area AR21 do not overlap each other in plan view.

The region of the area AR11 of the light guide LG1, which overlaps the area AR22 is designated as an overlapping region OR1, and the region of the area AR22, which overlaps the area AR11 is designated as an overlapping region OR2. Light from the light source element LSM1 entering from the side surface LG1s2 is gradually emitted from a plurality of projecting portions TV1a as it approaches the side surface LG1s1. In order to emit light in the area closer to the side surface LG1s1 with respect to the central portion LG1c of the light guide LG1, projecting portions TV1a are necessary as well in the area closer to the light entry side with respect to the central portion LG1c.

The above is also the case for the light guide LG2. Therefore, projecting portions TV2a are necessary as well on the light entry side (the side surface LG2s1 side) with respect to the central portion LG2c of the light guide LG2.

At an end portion on the side surface LG1s2 side of the area AR11 (overlapping OR1), all the incident light is emitted downward, and therefore the luminance of the emitted light is reduced. Similarly, at an end portion on the side surface LG2s1 side of the area AR22 (overlapping region OR2), the luminance of the emitted light is reduced because all the incident light is emitted to the outside. Therefore, with the overlapping region OR1 and the overlapping region OR2 thus provided, the reduced luminance can be compensated for with each other. As a result, the luminance of the light emitted from the light guide LG1 and the light guide LG2 can be made uniform.

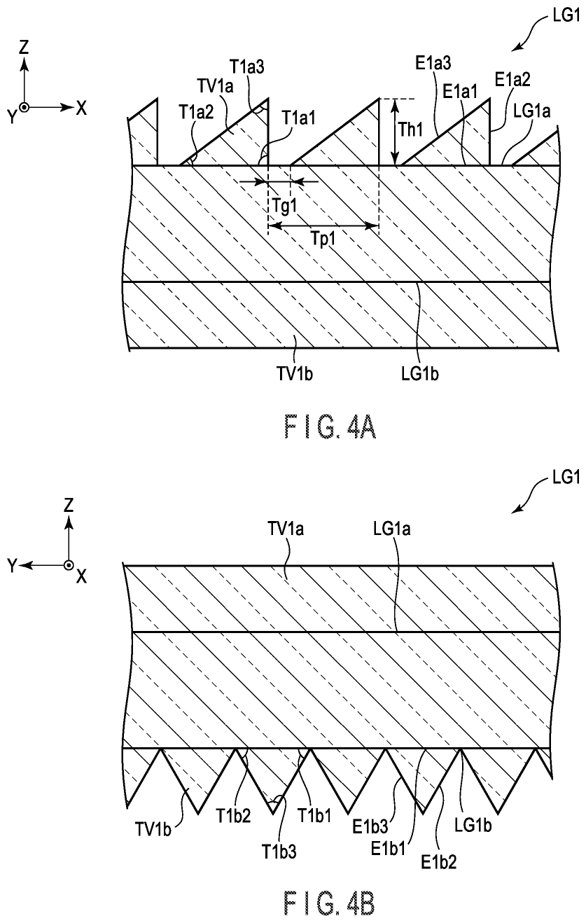

FIGS. 4A and 4B are schematic enlarged cross-sectional views showing the shape of the projecting portions of the illumination device. In each of the projecting portions TV1a of the light guide LG1, the cross-sectional shape in the X-Z plane is a scalene triangle (see FIG. 4A). Among the edges of the scalene triangle, the edge tangent to the main surface LG1a of the light guide LG1 is designated as an edge E1a1. The scalene triangle includes an edge E1a2 and an edge E1a3 extending from the edge E1a1. The angle formed by the edge E1a1 and the edge E1a2 is designated as an angle T1a1, the angle formed by the edge E1a1 and the edge E1a3 is designated as an angle T1a2, and the angle formed by the edge E1a2 and the edge E1a3 is designated as an angle T1a3.

As shown in FIG. 4A, the lengths of the edges E1a1, E1a2, and E1a3 are all different from each other.

The angle T1a1 should preferably be 90° (90 degrees). That is, the scalene triangle should preferably be a right triangle. When the angle T1a1 is 90°, light incident on the projecting portions TV1a can be efficiently reflected, which is desirable. Note here that the configuration is not limited to this, and it suffices if the angle T1a1 is close to 90°, for example, in a range between 80° and 90°.

The angle T1a2 is an acute angle, for example, 15° (15 degrees). The angle T1a3 is an acute angle, for example, 75°. The angle T1a2 and the angle T1a3 can be determined according to the light distribution angle of the emitted light.

The gap and pitch between each adjacent pair of the projecting portions TV1a are defined as a gap Tg1 and a pitch Tp1, respectively. The pitch Tp1 is the sum of the length of the edge E1a1 and the gap Tg1. When the pitch Tp1 is set to a predetermined fixed value, the distribution of the projecting portions TV1a can be controlled by changing the length of the edge E1a1.

In each of the projecting portions TV1b of the light guide LG1, the cross-sectional shape thereon in the Y-Z plane is an isosceles triangle (see FIG. 4b). Among the edges of the isosceles triangle, the edge tangent to the main surface LG1b of the light guide LG1 is designated as an edge E1b1. The isosceles triangle includes an edge E1b2 and an edge E1b3, which extend from the edge E1b1. The angle formed by the edge E1b1 and the edge E1b2 is designated as an angle T1b1, the angle formed by the edge E1b1 and the edge E1b3 is designated as an angle T1b2, and the angle formed by an edge E1b2 and an edge E1b3 is designated as an angle T1b3.

In the isosceles triangle, the base angle T1b1 and angle T1b2 are equal to each other. The angle T1b3, which is the vertex angle, may as well be equal to the angle T1b1 and the angle T1b2. In other words, the cross-sectional shape of the projecting portions TV1b, which is the isosceles triangle, may as well be an equilateral triangle.

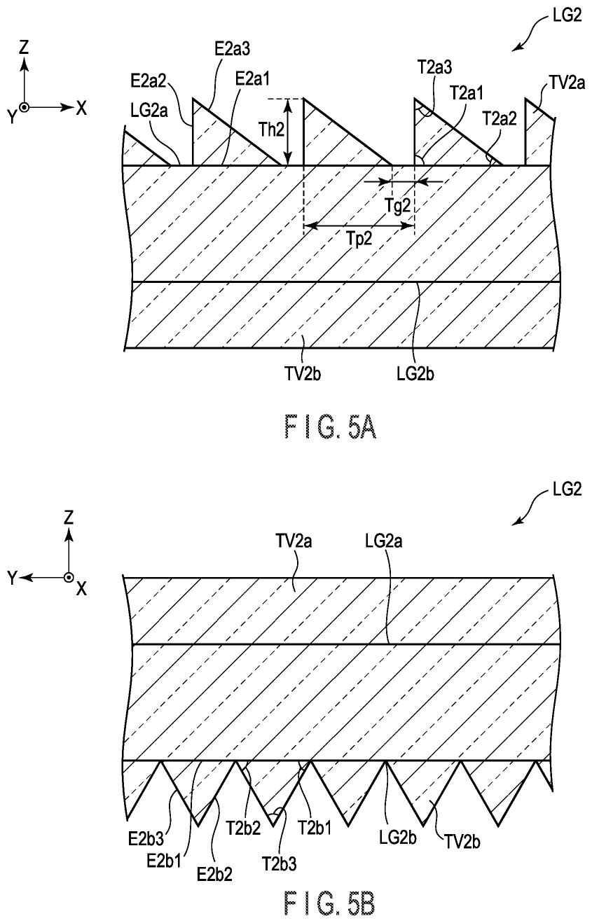

FIGS. 5A and 5B are schematic enlarged cross-sectional views each showing the shape of the projecting portions of the illumination device. In each of the projecting portions TV2a of the light guide LG2, the cross-sectional shape thereof in the X-Z plane is an scalene triangle (see FIG. 5A). Among the edges of the scalene triangle, the edge tangent to the main surface LG2a of the light guide LG2 is designated as an edge E2a1. The scalene triangle includes an edge E2a2 and an edge E2a3, which extend from the edge E2a1. The angle formed by the edge E2a1 and the edge E2a2 is designated as an angle T2a1, the angle formed by the edge E2a1 and the edge E2a3 is designated as an angle T2a2, and the angle formed by the edge E2a2 and the edge E2a3 is designated as an angle T2a3.

As shown in FIG. 5A, the lengths of the edge E2a1, the edge E2a2, and the edge E2a3 are all different from each other.

The angle T2a1 should preferably be 90°. In other words, the scalene triangle should preferably be a right triangle. When the angle T2a1 is 90°, light incident on the projecting portion TV2a can be reflected efficiently, which is suitable. However, the configuration is not limited to this, but it suffices if the angle T2a1 is close to 90°, for example, between in a range of 80° and 90°.

The angle T2a2 is an acute angle, for example, 15°. The angle T2a3 is an acute angle, for example, 75°. The angle T2a2 and the angle T2a3 should be determined according to the light distribution angle of the emitted light.

The gap and pitch between each adjacent pair of the projecting portions TV2a are defined as a gap Tg2 and a pitch Tp2, respectively. The pitch Tp2 is the sum of the length of the edge E2a1 and the gap Tg2. As in the case of the projecting portions TV1a, when the pitch Tp2 is set to a predetermined fixed value, the distribution of the projecting portion TV2a can be controlled by changing the length of the edge E2a1.

The cross-sectional shape of each of the projecting portions TV1a of the light guide LG1 and the cross-sectional shape of each of the projecting portions TV2a of the light guide LG2 are arranged in line symmetrical positions with respect to a direction parallel to the Y-Z plane. In this embodiment, the lengths of the edges E1a1 and E2a1, the lengths of the edges E1a2 and E2a2, and the lengths of the edges E1a3 and E2a3 are equal to each other in each case.

The degrees of the angle T1a1 and the angle T2a1, those of the angle T1a2 and the angle T2a2, and those of the angle T1a3 and the angle T2a3 are equal to each other in each case.

In each of the projecting portions TV2b of the light guide LG2, the cross-sectional shape thereof in the Y-Z plane is an isosceles triangle (see FIG. 5B). Among the edges of the isosceles triangle, the edge tangent to the main surface LG2b of the light guide LG2 is designated as an edge E2b1. The isosceles triangle includes an edge E2b2 and an edge E2b3, which extend from the edge E2b1. The angle formed by the edge E2b1 and the edge E2b2 is designated as an angle T2b1, the angle formed by the edge E2b1 and the edge E2b3 is designated as an angle T2b2, and the angle formed by the edge E2b2 and the edge E2b3 is designated as an angle T2b3.

In the isosceles triangle, the base angle T2b1 and angle T2b2 are equal to each other. The angle T2b3, which is the vertex angle, may as well be equal to the angle T2b1 and the angle T2b2. In other words, the cross-sectional shape of the projecting portions TV2b, which is the isosceles triangle, may as well be an equilateral triangle.

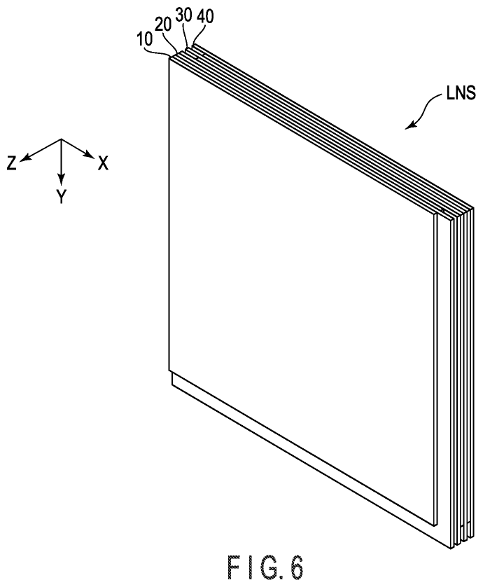

Here, the liquid crystal lens LNS will be explained. FIG. 6 is a perspective view showing a configuration of the liquid crystal lens.

The liquid crystal lens LNS comprises a first liquid crystal cell 10, a second liquid crystal cell 20, a third liquid crystal cell 30, and a fourth liquid crystal cell 40. The liquid crystal lens LNS of this embodiment is of a type which comprise two or more liquid crystal cells, and is not limited to the configuration with four liquid crystal cells, as shown in the example in FIG. 6.

In the third direction Z, the fourth liquid crystal cell 40, the third liquid crystal cell 30, the second liquid crystal cell 20, and the first liquid crystal cell 10 overlap in this order.

Light LT1 and light LT2 emitted from the illumination element IL2 pass through the fourth liquid crystal cell 40, the third liquid crystal cell 30, the second liquid crystal cell 20, and the first liquid crystal cell 10, in that order. As will be described later, the first liquid crystal cell 10, the second liquid crystal cell 20, the third liquid crystal cell 30, and the fourth liquid crystal cell 40 are configured to refract part of polarization components of the incident light. With the liquid crystal lens LNS, it is possible to diffuse and focus the light.

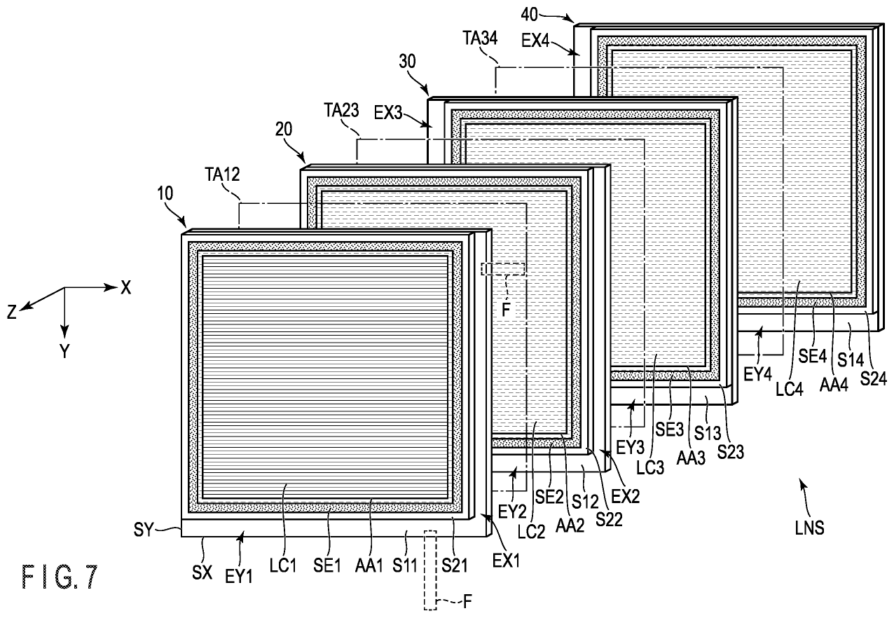

FIG. 7 is an exploded view schematically showing the liquid crystal lens illustrated in FIG. 6.

The first liquid crystal cell 10 comprises a first transparent substrate S11, a second transparent substrate S21, a liquid crystal layer LC1, and a seal SE1. The first transparent substrate S11 and the second transparent substrate S21 are adhered together by the seal SE1. The liquid crystal layer LC1 is held between the first transparent substrate S11 and the second transparent substrate S21 and sealed by the seal SE1. The effective area AA1, where incident light can be refracted, is formed on an inner side of the region enclosed by the seal SE1.

The first transparent substrate S11 includes an extending portion EX1 extending outwardly from the second transparent substrate S21 along the first direction X and an extending portion EY1 extending outwardly from the second transparent substrate S21 along the second direction Y. At least one of the extending portion EX1 and the extending portion EY1 is connected to a flexible wiring substrate F indicated by the dotted line.

The second liquid crystal cell 20 comprises a first transparent substrate S12, a second transparent substrate S22, a liquid crystal layer LC2, and a seal SE2. The effective area AA2 is formed on an inner side of the region enclosed by the seal SE2.

The first transparent substrate S12 includes an extending portion EX2 and an extending portion EY2. In the third direction Z, the extending portion EX2 overlaps the extending portion EX1 and the extending portion EY2 overlaps the extending portion EY1. A flexible wiring substrate is connected to at least one of the extending portion EX2 and the extending portion EY2, but the illustration of the flexible wiring substrate is omitted in the other cells, that is, the second liquid crystal cells 20 to the fourth liquid crystal cell 40.

The third liquid crystal cell 30 comprises a first transparent substrate S13, a second transparent substrate S23, a liquid crystal layer LC3, and a seal SE3. The effective area AA3 is formed on an inner side of the region enclosed by the seal SE3.

The first transparent substrate S13 includes an extending portion EX3 and an extending portion EY3. In the third direction Z, the extending portion EY3 overlaps the extending portion EY2. The extending portion EX3 does not overlap the extending portion EX2 and is located on the opposite side to the extending portion EX2.

The fourth liquid crystal cell 40 comprises a first transparent substrate S14, a second transparent substrate S24, a liquid crystal layer LC4, and a seal SE4. The effective area AA4 is formed on an inner side of the region enclosed by the seal SE4.

The first transparent substrate S14 includes an extending portion EX4 and an extending portion EY4. In the third direction Z, the extending portion EX4 overlaps the extending portion EX3 and the extending portion EY4 overlaps the extending portion EY3.

Between the first liquid crystal cell 10 and the second liquid crystal cell 20, a transparent adhesive layer TA12 is disposed. The transparent adhesive layer TA12 adheres the first transparent substrate S11 and the second transparent substrate S22 together.

Between the second liquid crystal cell 20 and the third liquid crystal cell 30, a transparent adhesive layer TA23 is disposed. The transparent adhesive layer TA23 adheres the first transparent substrate S12 and the second transparent substrate S23 together.

Between the third liquid crystal cell 30 and the fourth liquid crystal cell 40, a transparent adhesive layer TA34 is disposed. The transparent adhesive layer TA34 adheres the first transparent substrate S13 and the second transparent substrate S24 together.

The first transparent substrate S11 to the first transparent substrate S14 are each formed into a square shape and have equivalent sizes. For example, in the first transparent substrate S11, the side SX and the side SY are orthogonal to each other, and the length of the side SX is identical to the length of the side SY.

With the above-described configuration, when the first liquid crystal cell 10, the second liquid crystal cell 20, the third liquid crystal cell 30, and the fourth liquid crystal cell 40 are adhered to each other, the sides thereof along the first direction X overlap each other, as shown in FIG. 6, and the sides thereof along the second direction Y as well overlap each other.

Note that the second substrate, which has a shape substantially the same as that of the area through which light passes (the effective area, which will be described later), may be made square-shaped, and the first substrate may be made to have a polygonal shape other than square-shaped, for example, rectangular-shaped. Further, it is also possible to adopt a configuration in which one of the extending portions of each liquid crystal cell is deleted.

Next, the configuration of each liquid crystal cell will be described more specifically. Note that the following description is directed to, as an example, the first liquid crystal cell 10 of the plurality of the liquid crystal cells which constitute the liquid crystal lens LNS, but the configuration of each of the other liquid crystal cells from the second liquid crystal cell 20 to the fourth liquid crystal cell 40 is approximately the same as that of the first liquid crystal cell 10, except for the extending direction of the strip electrodes.

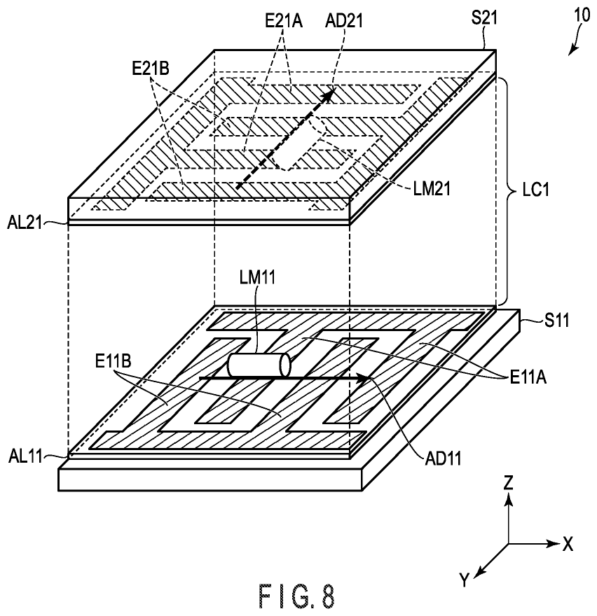

FIG. 8 is a perspective view schematically showing the first liquid crystal cell 10 illustrated in FIG. 7.

The first liquid crystal cell 10 comprises, in the effective area AA1, a first strip electrode E11A and a second strip electrode E11B, a first alignment film AL11, a third strip electrode E21A and a fourth strip electrode E21B, and a second alignment film AL21.

The first strip electrode E11A and the second strip electrode E11B are located between the first transparent substrate S11 and the first alignment film AL11, are spaced apart from each other and extend in the same direction. The first strip electrode E11A and the second strip electrode E11B may be in contact with the first transparent substrate S11 or may have an insulating film interposed between them and the first transparent substrate S11. Further, an insulating film may be interposed between the first strip electrode E11A and the second strip electrode E11B, and the first strip electrode E11A may be located in a layer different from that of the second strip electrode E11B.

There are a plurality of first strip electrodes E11A and a plurality of second strip electrodes E11B, which are aligned in the first direction X and arranged alternately. The plurality of first strip electrodes E11A are electrically connected to each other and configured so that the same voltage is applied thereto. The plurality of second strip electrodes E11B are electrically connected to each other and configured so that the same voltage is applied thereto. However, the voltage applied to the second strip electrode E11B is controlled to be different from the voltage applied to the first strip electrode E11A.

The first alignment film AL11 covers the first strip electrodes E11A and the second strip electrodes E11B. The alignment treatment direction AD11 of the first alignment film AL11 is in the first direction X. Note that the alignment treatment of each alignment film may be a rubbing treatment or a photo-alignment treatment. The alignment treatment direction may as well be referred to as a rubbing direction. Generally, when no voltage is being applied to the liquid crystal layer (initial alignment state), liquid crystal molecules located near the alignment film are initially aligned in a predetermined direction by an alignment restriction force along the alignment treatment direction of the alignment film. That is, in the example presented here, the initial alignment direction of the liquid crystal molecules LM11 along the first alignment film AL11 is in the first direction X. The alignment direction AD11 intersects the first strip electrode E11A and the second strip electrode E11B.

The third strip electrode E21A and the fourth strip electrode E21B are located between the second transparent substrate S21 and the second alignment film AL21, are spaced apart from each other and extend in the same direction. The third strip electrode E21A and the fourth strip electrode E21B may be in contact with the second transparent substrate S21 or an insulating film may be interposed between them and the second transparent substrate S21. Further, an insulating film may be interposed between the third strip electrode E21A and the fourth strip electrode E21B, and the third strip electrode E21A may be located in a layer different from that of the fourth strip electrode E21B.

There are a plurality of third strip electrodes E21A and a plurality of fourth strip electrodes E21B, which are aligned in the second direction Y and arranged alternately. The plurality of third strip electrodes E21A are electrically connected to each other and configured so that the same voltage is applied thereto. The plurality of fourth strip electrodes E21B are electrically connected to each other and configured so that the same voltage is applied thereto. However, the voltage applied to the fourth strip electrodes E21B is controlled to be different from the voltage applied to the third strip electrodes E21A. The extending direction of the first strip electrodes E11A and the second strip electrodes E11B is orthogonal to the extending direction of the third strip electrodes E21A and the fourth strip electrodes E21B, as will be described in detail later.

The second alignment film AL21 covers the third strip electrodes E21A and the fourth strip electrodes E21B. The alignment direction AD21 of the second alignment film AL21 is in the second direction Y. That is, in the example presented here, the initial alignment direction of the liquid crystal molecules LM21 along the second alignment film AL21 is in the second direction Y. The alignment direction AD11 of the first alignment film AL11 and the alignment direction AD21 of the second alignment film AL21 are orthogonal to each other. The alignment direction AD21 intersects the third strip electrodes E21A and the fourth strip electrodes E21B.

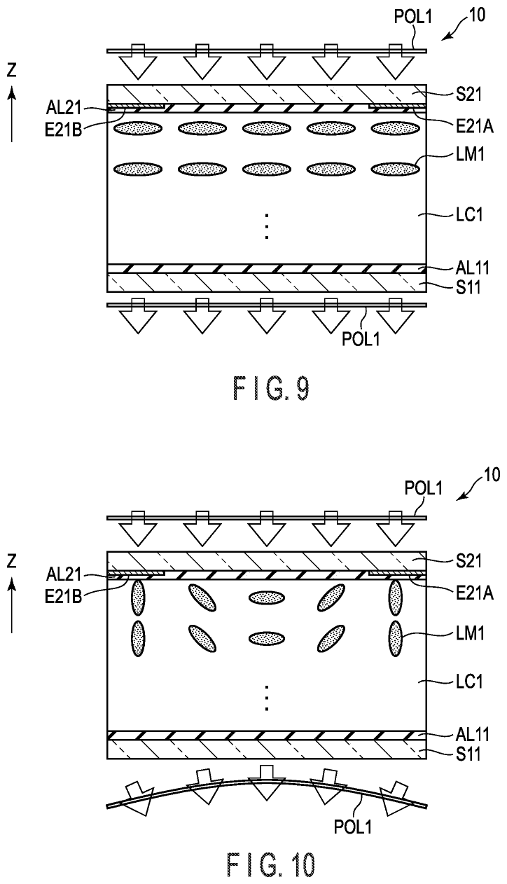

The optical activity in the first liquid crystal cell 10 will now be described with reference to FIGS. 9 and 10. In FIGS. 9 and 10, only the configurations necessary for explanation, such as the liquid crystal molecules LM1 in the vicinity of the transparent substrate S11, are illustrated.

FIG. 9 is a diagram schematically showing the first liquid crystal cell 10 in an off state (OFF) where no electric field is formed in the liquid crystal layer LC1.

In the liquid crystal layer LC1 in the off state, the liquid crystal molecules LM1 are initially aligned. In an off state such as this, the liquid crystal layer LC1 has a substantially uniform refractive index distribution. Therefore, a polarization component POL1, which is incident light to the first liquid crystal cell 10, passes through the liquid crystal layer LC1 without substantially being refracted (or diffused).

As shown in FIG. 9, the initial alignment directions of the liquid crystal molecules of the liquid crystal layer LC1 are crossed at 90° between the transparent substrates S11 and S21 in the first liquid crystal cell 10. The liquid crystal molecules of the liquid crystal layer LC1 are aligned in one of the first direction X and the second direction Y on a second transparent substrate S21 side. The liquid crystal molecules gradually change their alignment from the one of the directions to the other of the first direction X and the second direction Y as the location is closer toward the first transparent substrate S11. The liquid crystal molecules are aligned in the other direction on a first transparent substrate S11 side.

The direction of the polarization component changes in accordance with such a change in the alignment of the liquid crystal layer LC1. More specifically, the polarization component having its polarization axis on this one direction changes its polarization axis to the other direction in the process of passing through the liquid crystal layer LC1. On the other hand, the polarization component having the polarization axis on the other direction changes its polarization axis to the one direction in the process of passing through the liquid crystal layer LC1. Therefore, when viewed in terms of these mutually orthogonal polarization components, their polarization axes are interchanged in the process of passing through the first liquid crystal cell 10. Such an effect of changing the direction of the polarization axes may be referred to as optical rotation in the following descriptions.

FIG. 10 is a diagram schematically showing the first liquid crystal cell 10 in the on state (ON), where an electric field is formed in the liquid crystal layer LC1.

In the on state, a potential difference is created between the first strip electrodes E11A and the second strip electrodes E11B, and thus an electric field is formed in the liquid crystal layer LC1. For example, when the liquid crystal layer LC1 has positive dielectric constant anisotropy, the liquid crystal molecules LM1 are aligned so that their long axes are along the electric field. Note here that the range covered by the electric field between the first strip electrodes E11A and the second strip electrodes E11B is mainly about ½ of the thickness of the liquid crystal layer LC1. Therefore, as shown in FIG. 10, in the range of the liquid crystal layer LC1, that is close to the first transparent substrate S11, a region in which the liquid crystal molecules LM1 are aligned substantially perpendicular to the substrate, a region in which the liquid crystal molecules LM1 are aligned diagonally to the substrate, a region in which the liquid crystal molecules LM1 are aligned substantially horizontal to the substrate, etc., are formed.

The liquid crystal molecules LM1 have a refractive index anisotropy Δn. Therefore, the liquid crystal layer LC1 in the on state has a refractive index distribution or retardation distribution according to the alignment state of the liquid crystal molecules LM1. The retardation here is expressed as: Δn·d, where the thickness of the liquid crystal layer LC1 is represented by d. Note that in this example, a positive type liquid crystal is used as the liquid crystal layer LC1, but a negative type liquid crystal can as well be adopted by taking the alignment direction, etc. into consideration.

In an on state such as this, the polarization component POL1 is diffused under the influence of the refractive index distribution of the liquid crystal layer LC1 as it passes through the liquid crystal layer LC1. More specifically, the polarization component having a polarization axis in one of the first direction X and the second direction Y is diffused under the influence of the refractive index distribution of the liquid crystal layer LC1 and is rotated in the other direction of the first direction X and the second direction Y. The polarization component having the polarization axis in the other direction is not affected by the refractive index distribution and passes through the liquid crystal layer LC1 without being diffused but rotated only in that one direction.

Note that FIG. 10 illustrates the case where an electric field is formed by the potential difference between the first strip electrodes E11A and the second strip electrodes E11B, but when diffusing incident light by the first liquid crystal cell 10, it is preferable to form an electric field by the potential difference between the third strip electrodes E21A and the fourth strip electrodes E21B as well. With this configuration, the alignment state of not only the liquid crystal molecules in the vicinity of the first transparent substrate S11 but also that of the liquid crystal molecules in the vicinity of the second transparent substrate S21 can be controlled, and thus a predetermined refractive index distribution can be formed in the liquid crystal layer LC1.

More specifically, the liquid crystal layer LC1 on the second transparent substrate S21 side also has a refractive index distribution, and thus the polarization component that is rotated in the other direction of the first direction X and the second direction Y in the process of passing through the liquid crystal layer LC1 is diffused. In other words, the polarization component diffused on the transparent substrate S11 side is further diffused on the transparent substrate S21 side and emitted from the first liquid crystal cell 10. On the other hand, the polarization component that is rotated in the one of the first direction X and the second direction Y in the process of passing through the liquid crystal layer LC1 is emitted from the first liquid crystal cell 10 without being affected by the refractive index distribution.

Such diffusion and rotation of the polarization components occur in the second liquid crystal cell 20 as well. That is, the polarization component of light emitted from the light source, which has a polarization axis directed in one of the first direction X and the second direction Y changes the direction of its polarization axis from the one to the other of the first direction X and the second direction Y as it passes through the first liquid crystal cell 10. Further, it passes through the second liquid crystal cell 20, the component changes the direction of its polarization axis from the other to the one of the directions.

Here, when the liquid crystal molecules parallel to the polarization component have a refractive index distribution in this process, the polarization component is diffused according to the refractive index distribution. Similarly, the polarization component of light emitted from the light source, which has a polarization axis directed in the other one of the first direction X and the second direction Y changes the direction of its polarization axis from the other one to the one of the first direction X and the second direction Y as it passes through the first liquid crystal cell 10. Further, as it passes through the second liquid crystal cell 20, the direction of the polarization axis is changed from the one to the other one. Further, when the liquid crystal molecules parallel to the polarization component have a refractive index distribution in this process, the polarization component is diffused according to the refractive index distribution.

The same phenomenon occurs in the third liquid crystal cell 30 and the fourth liquid crystal cell 40 as well, but these correspond to the first liquid crystal cells and second liquid crystal cells when rotated by 90°, the polarization components that cause the diffusion effect are switched over.

That is, in the configuration in which the first liquid crystal cell 10, the second liquid crystal cell 20, the third liquid crystal cell 30, and the fourth liquid crystal cell 40 are stacked one on another, for example, the first liquid crystal cell 10 and the fourth liquid crystal cell 40 are configured to scatter (diffuse) the polarization component POL1, which is mainly of the p-polarized light, whereas the second liquid crystal cell 20 and the third liquid crystal 30 are configured to scatter (diffuse) the polarization component POL2, which is mainly of the s-polarized light.

In this embodiment, the liquid crystal lens LNS with four liquid crystal cells is described, but this embodiment is not limited to this configuration. It suffices if the liquid crystal lens LNS includes at least one liquid crystal cell, but it may include two or more liquid crystal cells.

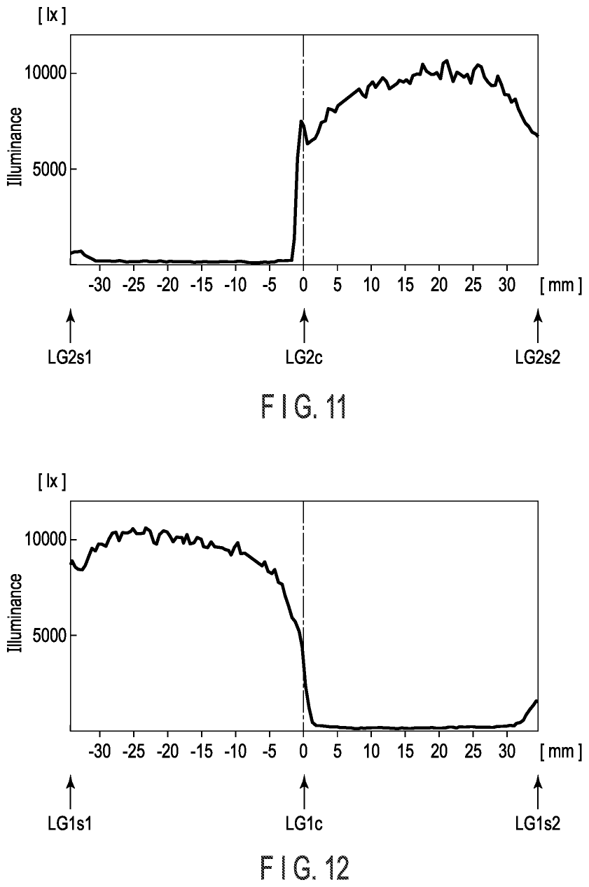

FIGS. 11 and 12 are diagrams each showing illuminance distribution of light emitted from the illumination element. FIGS. 11 and 12 show the illuminance distributions in the illumination elements IL2 and IL1, respectively.

In FIG. 11, the horizontal axis indicates the distance from the central portion LG2c of the light guide LG2 in the first direction X, where the position of the central portion LG2c is defined as 0, and the vertical axis indicates the illuminance. As to the horizontal axis, the left end corresponds to the location of the side surface LG2s1 and the right end to the side surface LG2s2. The figure illustrates that as the location is closer to the side surface LG2s1, it approaches the light source element LSM2. On the other hand, the closer to the side surface LG2s2, the further away from the light source element LSM2.

At the locations from the side surface LG2s1 to the central portion LG1c, the illuminance of the illumination element IL1 is substantially zero (0). The illuminance rises sharply near the central portion LG2c, and at the locations from the central portion LG2c to the side surface LG2s2, the illuminance is approximately 5,000 [lx] or higher. The maximum value exists near the location 20 mm away from the central portion LG2c to the side surface LG2s2. The maximum value is approximately 10,000 [lx].

In FIG. 12, the horizontal axis indicates the distance from the central portion LG1c of the light guide LG1 in the first direction X, where the central portion LG1c is designated as 0, and the vertical axis indicates the illuminance. On the horizontal axis, the left end corresponds to the location of the side surface LG1s1 and the right end to side the surface LG1s2. It is illustrated that as the location is closer to the side surface LG1s1, it is further away from the light source element LSM1. On the other hand, the closer to the side surface LG1s1, the closer to the light source element LSM1.

The illuminance of the illumination element IL1 is substantially zero (0) at the locations from the side surface LG1s2 to the central portion LG1c. The illuminance rises sharply around the central portion LG1c, and at the locations from the central portion LG1c to the side surface LG1s1, the illuminance is approximately 5,000 [lx] or higher. The maximum value exists near the location 20 mm away from the central portion LG1c to the side surface LG1s1 (which is the location of −20 [mm]). The maximum value is approximately 10,000 [lx].

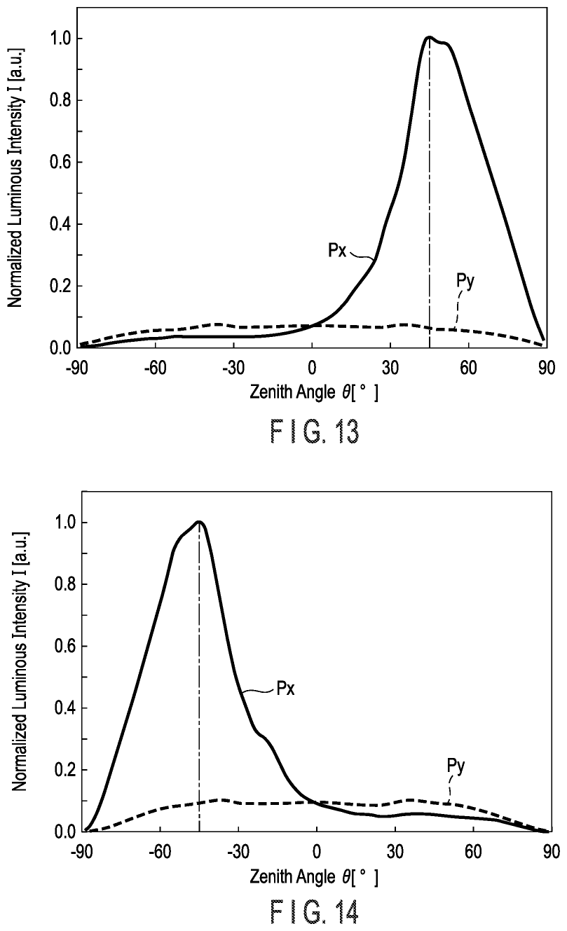

FIGS. 13 and 14 are diagrams each showing the relationship of the normalized luminous intensity of the emitted light to the zenith angle in the illumination elements. FIG. 13 shows plots for the illumination element IL2 and FIG. 14 are plots for the illumination element IL1. The relationship between the vertex angle θ [° (degree(s))] and the normalized luminous intensity I [a.u.] may as well be referred to as the emission angle distribution.

In FIGS. 13 and 14, the vertex angle on the horizontal axis indicates the angle of the emitted light in the first direction X or the angle of the emitted light in the second direction Y. The angle of the emitted light in the first direction X is the angle between the emitted light from the light source elements and the Y-Z plane. The angle of the emitted light in the second direction Y is the angle between the emitted light from the light source elements and the X-Z plane. In the ideal collimated light, the angle of the emitted light in the first direction X and second direction Y is 0°, but in the actual emitted light, there is a distribution of emission angles.

In FIGS. 13 and 14, the emission angle distribution Px in the first direction X is indicated by a solid line and the emission angle distribution Py in the second direction Y is indicated by a dotted line. As shown in FIG. 13, the illumination element IL2 exhibits a maximum normalized luminous intensity I at a vertex angle of 45° for the first direction X. For the second direction Y, the normalized luminous intensity I is substantially constant even if the vertex angle θ changes. This is because it is not diffused by the liquid crystal lens LNS.

As shown in FIG. 14, for the first direction X, the illumination element IL1 exhibits a maximum normalized luminous intensity I at a vertex angle of −45°. For the second direction Y, the normalized luminous intensity I is substantially constant even when the angle θ is changed, as is the case of the illumination element IL2.

Let us return to FIG. 2. The light LT1p and the light LT2p correspond to the emitted light shown in FIGS. 12 and 11, respectively. The angle Rip and the angle R2p correspond to the vertex angles in the first direction X shown in FIGS. 14 and 13, respectively.

By the illumination element IL1 and the illumination element IL2, the light LT1 and the light LT2 are emitted more outwardly as light LT1p and light LT2p, respectively. On the other hand, by the liquid crystal lens LNS in the on state, the light is emitted more inwardly as polarized light LT1c and polarized light LT2c.

As described above, by changing the emission angle, it is possible to illuminate light at a desired location.

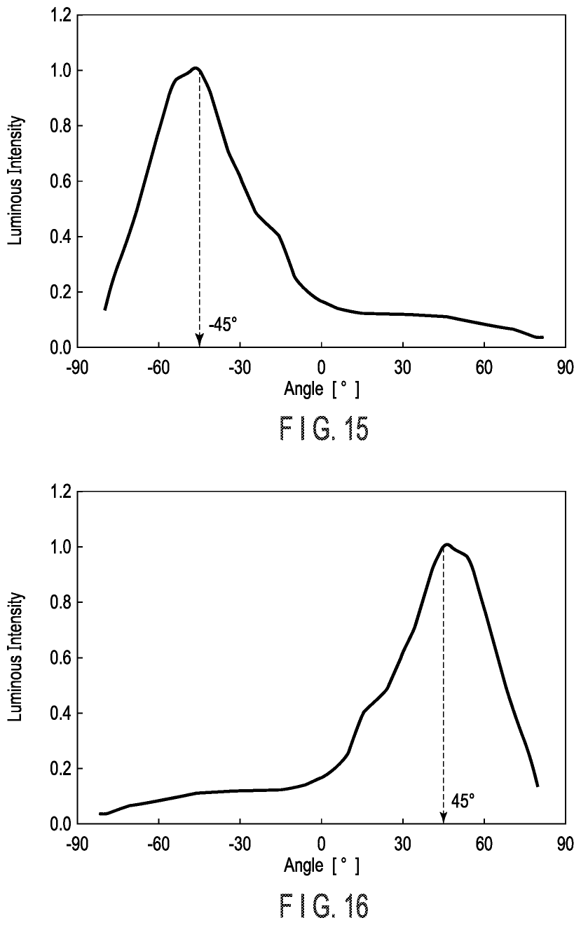

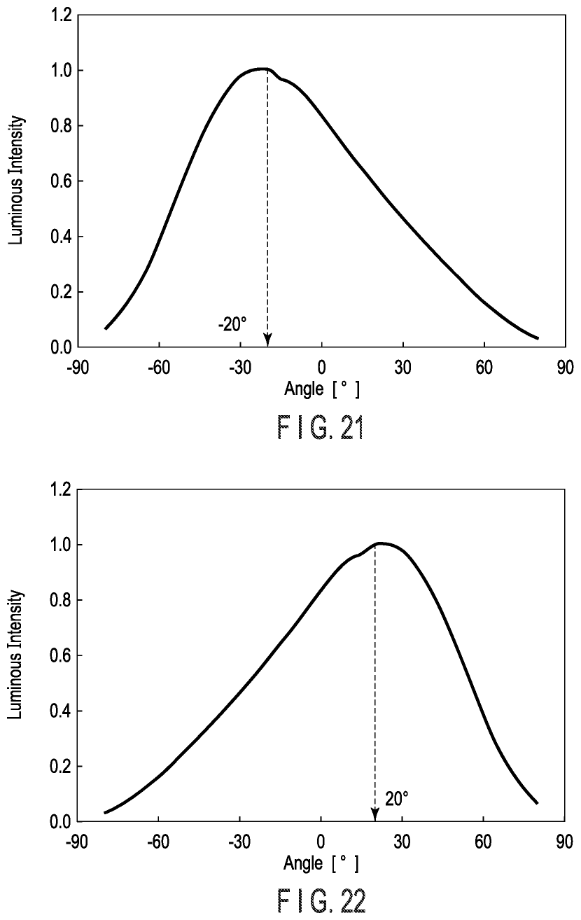

FIGS. 15, 16, 17, 18, 19, 20, 21, 22, and 23 are diagrams each showing the relationship of the luminous intensity of the emitted light to the angle of the emitted light in this illumination device. FIGS. 15, 16, and 17 each show the relationship between the angle (which may as well be referred to as the emission angle) and the luminous intensity of emitted light in the configuration of the illumination device ILD in which the liquid crystal lens LNS is not provided. FIGS. 18, 19, and 20 each show the relationship between the angle and the luminous intensity of the emitted light of the illumination device ILD when the liquid crystal lens LNS is in the off state. FIGS. 21, 22, and 23 each show the relationship between the angle and the luminous intensity of the emitted light of the illuminator ILD when the liquid crystal lens LNS is in the on state. In FIGS. 15 to 23, the angle [° ] on the horizontal axis is similar to the vertex angle θ in FIGS. 13 and 14. The luminous intensity on the vertical axis is similar to the normalized luminous intensity in FIGS. 13 and 14.

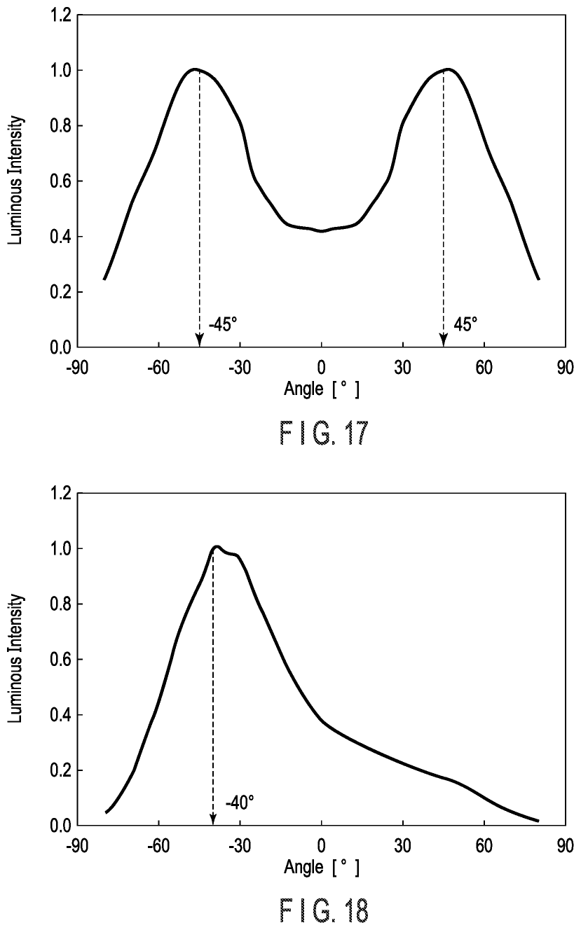

FIGS. 15, 18, and 21 show the cases where the illumination element IL1 is turned on, that is, the light source elements LSM1 are turned on. FIGS. 16, 19, and 22 show the cases in which the illumination element IL2 is turned on, that is, the light source elements LSM2 are turned on. FIGS. 17, 20, and 23 show the cases where both the illumination element IL1 and the illumination element IL2 are turned on, that is, both the light source elements LSM1 and the light source elements LSM2 are turned on.

As shown in FIG. 15, the luminous intensity of the emitted light relating to the illumination element IL1 in the configuration without the liquid crystal lens LNS becomes maximum when the emission angle is −45°. Similarly, as shown in FIG. 16, the luminous intensity of the emitted light relating to the illumination element IL2 becomes maximum when the emission angle is 45°. When both the illumination elements IL1 and IL2 are turned on, the luminous intensity becomes maximal when the emission angles are at −45° and 45°, as shown in FIG. 17.

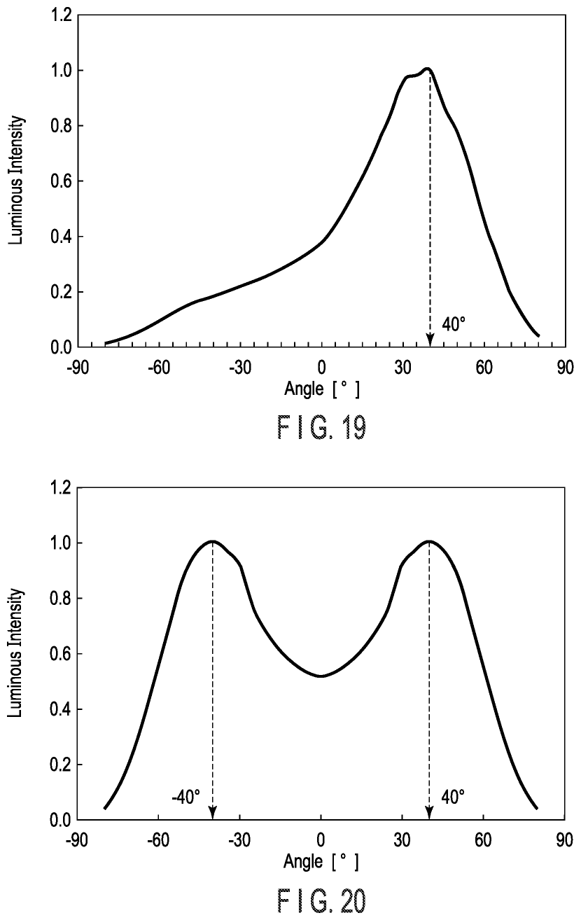

When the liquid crystal lens LNS is provided but not turned on, the luminous intensity of the emitted light relating to the illumination element IL1 becomes maximum when the emission angle is −40°, as shown in FIG. 18. Similarly, as shown in FIG. 19, the luminous intensity of the emitted light relating to the illumination element IL2 becomes maximum when the emission angle is 40°. When both the illumination elements IL1 and IL2 are turned on, the luminous intensity becomes maximal when the emission angle is at −40° and 40°, as shown in FIG. 20. When passing through the liquid crystal lens LNS, the emitted light is refracted, and therefore the emission angle becomes smaller than when the liquid crystal lens LNS is not provided. However, compared to the case where the liquid crystal lens LNS is turned on (which will be described later), the influence on the emission angle is small.

In the case where the liquid crystal lens LNS is turned on, as shown in FIG. 21, the luminous intensity of the emitted light relating to the illumination element IL1 becomes maximum when the emission angle is −20°. Similarly, as shown in FIG. 22, the luminous intensity of the light emitted from the illumination element IL2 becomes maximum when the emission angle is 20°.

When the liquid crystal lens LNS is set in the on state, the emission angle of the maximum luminous intensity is smaller than when it is in the off state. This is because, when the liquid crystal lens LNS is in the on state, the light incident on the liquid crystal lens LNS is diffused under the influence of the refractive index distribution of the liquid crystal layer, as described above. With this configuration, the light emitted from the liquid crystal lens LNS can be directed more inwardly.

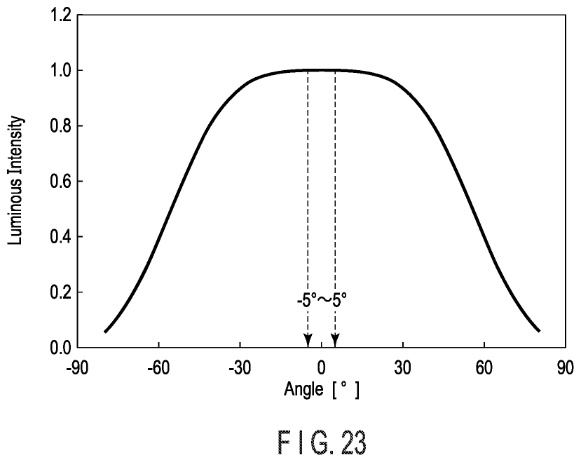

When both the illumination element IL1 and the illumination element IL2 are turned on, the luminous intensity becomes maximum when the emission angle is between −5° and 5°, as shown in FIG. 23. Since the emitted light from the illumination elements IL1 and IL2 are combined together, the luminous intensity is substantially constant in a range of the emission angles from −5° to 5°. Thus, when the liquid crystal lens LNS is in the on state and both the illumination element IL1 and the illumination element IL2 are turned on, light with a constant luminous intensity can be obtained for the emitting surface (irradiation surface).

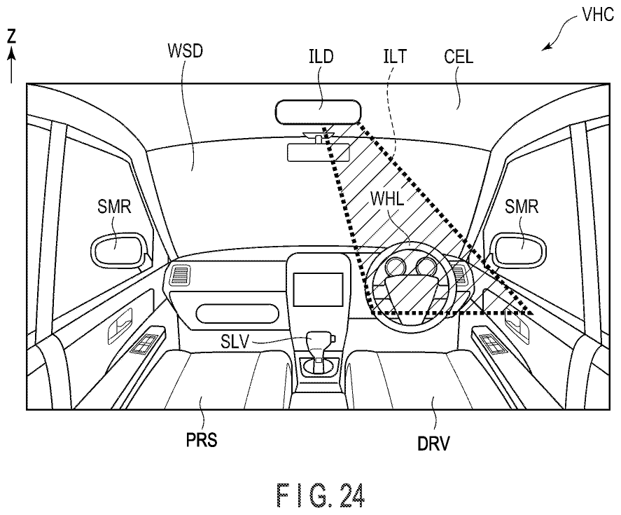

FIGS. 24, 25, 26, and 27 each show an example of the application of the illumination device of this embodiment. A vehicle VHC comprises a driver's seat DRV, a passenger's seat PRS, a windshield WSD, a shift lever SLV, a steering wheel WHL, a ceiling CEL, side mirrors SMR and the like. The lighting device ILD is installed in the ceiling CEL of the vehicle VHC.

FIG. 24 shows an example of the case where the illumination element IL2 of the illumination device ILD is set in the on state, that is, only the light source elements LSM2 are turned on, and the liquid crystal lens LNS is set in the off state. Spot light is irradiated as the illumination light ILT on the right side and on the outer side of the drawing. The illumination light ILT corresponds to the light LT2p.

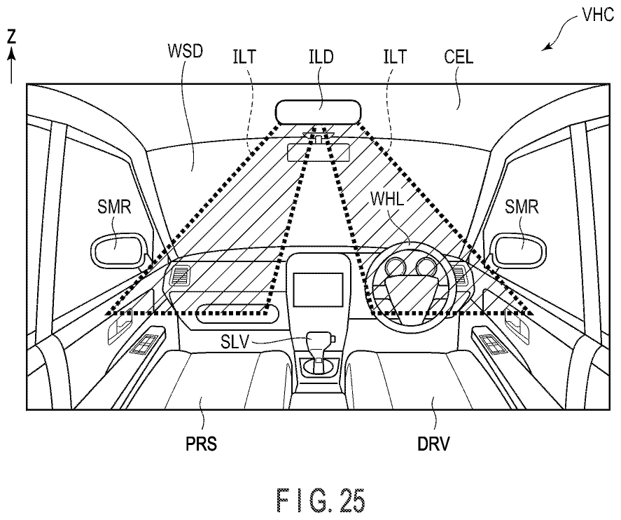

FIG. 25 shows an example of the case where both the illumination elements IL1 and IL2 of the illumination device ILD are set in the on state, that is, the light source elements LSM1 and the light source elements LSM2 are turned on and the liquid crystal lens LNS is set in the off state. Spot light is irradiated as the illumination light ILT on both the left and right sides and on the outer side of the drawing. The illumination light ILT corresponds to the light LT1p and the light LT2p. In the example shown in FIG. 25, on the outer side of the left and right sides of the drawing, the spot light is irradiated, whereas the inner side is not irradiated with the like, and becomes dark.

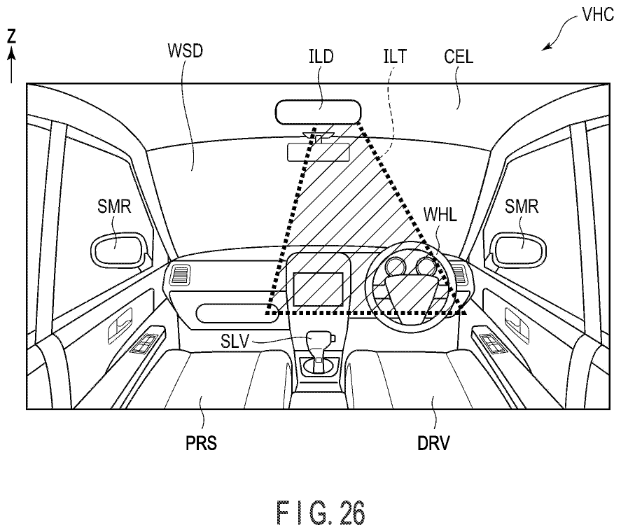

FIG. 26 shows an example of the case where the illumination element IL2 of the illumination device ILD is set in the on state, that is, only the light source elements LSM2 are turned on, and the liquid crystal lens LNS is set in the on state. The illumination light ILT is irradiated on the right side and on the inner side of the drawing. The illumination light ILT corresponds to the polarized light LT2c.

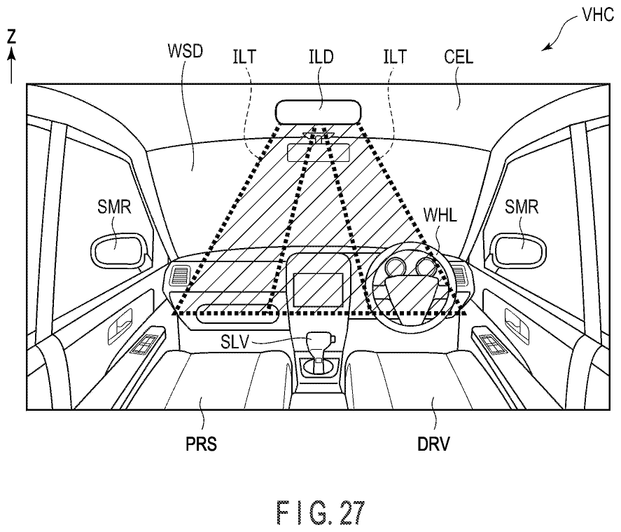

FIG. 27 shows an example of the case where both the illumination element IL1 and the illumination element IL2 of the illumination device ILD are set in the on state, that is, the light source elements LSM1 and the light source elements LSM2 are turned on, and the liquid crystal lens LNS is set in the on state. The illumination light ILT is irradiated on both the left and right sides and on the inner side of the drawing. The illumination light ILT corresponds to the polarized light LT1c and the polarized light LT2c. In the example shown in FIG. 27, the light irradiated on the left and right sides shifted to the inner side, and therefore unlike FIG. 25, the area where the illumination light ILT reaches is entirely irradiated. Further, as described with reference to FIG. 23, the luminous intensity is uniform with the illumination light ILT having such a configuration.

In the illumination device ILD of this embodiment, the light guide LG1 and the light guide LG2 comprise projecting portions TV1a and projecting portions TV1b, and projecting portions TV2a and projecting portions TV2b, respectively, on the side surface side far from the light source element LSM1 and the light source element LSM2. The liquid crystal lenses LNS which can diffuse light is provided so as to overlap the illumination element IL1 comprising the light guide LG1 and the illumination element IL2 comprising the light guide LG2.

With the illumination element IL1 and the illumination element IL2, it is possible to obtain illumination light with a large light distribution angle. With the liquid crystal lens, it is possible to obtain illumination light with a small light distribution angle. By controlling the turning on and off of the light source elements LSM1 and the light source elements LSM2 of the illumination element IL1 and the illumination element IL2, it is possible to illuminate either or both the left or right side.

According to the above-described embodiments, it is possible to provide an illumination device that can irradiate light at a desired location.

In this disclosure, the light source elements LSM1 and the light source elements LSM2 are the first light source elements and the second light source elements, respectively. The light guide LG1 and the light guide LG2 are the first light guide and the second light guide, respectively. The area AR11, The area AR12, the area AR21, and the area AR22 are the first area, the second area, the third area, and the fourth area, respectively.

In this disclosure, the side surface LG1s1 and the side surface LG1s2 of the light guide LG1, and the side surface LG2s1 and the side surface LG2s2 of the light guide LG2 are referred to as the first side surface, the second side surface, the third side surface, and the fourth side surface, respectively. The main surface LG1a and the main surface LG1b of the light guide LG1, and the main surface LG2a and the main surface LG2b of the light guide LG2 are referred to as the first main surface, the second main surface, the third main surface, and the fourth main surface, respectively.

In this disclosure, the projecting portions TV1a, the projecting portions TV1b, the projecting portions TV2a, and the projecting portions TV2b are referred to as the first projecting portions, the second projecting portions, the third projecting portions, and the fourth projecting portions, respectively.

Of the edges of the scalene triangle, which is the cross-sectional shape of the projecting portions TV1a, the edge E1a1, the edge E1a2, and the edge E1a3 are referred to as the first edge, the second edge, and the third edge, respectively. The angle T1a1 formed by the edge E1a1 and the edge E1a2, the angle T1a2 formed by the edge E1a1 and the edge E1a3, and the angle T1a3 formed by the edge E1a2 and the edge E1a3 are referred to as the first angle, the second angle, and the third angle, respectively.

Of the edges of the scalene triangle, which is the cross-sectional shape of the projecting portions TV2a, the edge E2a1, the edge E2a2, and the edge E2a3 are the fourth edge, the fifth edge, and the sixth edge, respectively. The angle T2a1 formed by the edge E2a1 and the edge E2a2, the angle T2a2 formed by the edge E2a1 and the edge E2a3, and the angle T2a3 formed by the edge E2a2 and the edge E2a3 are the fourth angle, the fifth angle, and the sixth angle, respectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illumination device comprising:
a first illumination element comprising a first light source element and a first light guide including a first area and a second area;
a second illumination element overlapping the first illumination element and comprising a second light source element and a second light guide including a third area and a fourth area; and
a liquid crystal cell overlapping the second illumination element, wherein
the first light guide includes a first side surface and a second side surface,
the first light source element is located to oppose the second side surface,
the second area is located between the second side surface of the first light guide and the first area,
the second light guide includes a third side surface and a fourth side surface,
the second light source element is located to oppose the third side surface of the second light guide,
the fourth area is located between the fourth side of the second light guide and the third area,
the fourth side surface is disposed closer to the second side surface than the first side surface,
the first area of the first light guide is provided with a first projecting portion on a first main surface and a second projecting portion on a second main surface on a side opposite to the first main surface,
the third area of the second light guide is provided with a third projecting portion on a third main surface on a side opposite to the second main surface and a fourth projecting portion on a fourth main surface on a side opposite to the third main surface,
the liquid crystal cell includes a first substrate provided with a first electrode, a second substrate provided with a second electrode, and a liquid crystal layer provided between the first substrate and the second substrate,
the first projecting portion and the third projecting portion have a cross-sectional shape of a scalene triangle, and
the second projecting portion and the fourth projecting portion have a cross-sectional shape of an isosceles triangle.

2. The illumination device according to claim 1, wherein
the first projecting portion and the third projecting portion are disposed in line symmetrical positions.

3. The illumination device according to claim 1, wherein
the first area and the third area overlap each other in plan view, and the second area and the fourth area overlap each other in plan view.

4. The illumination device according to claim 1, wherein
the second area and the fourth area do not overlap each other in plan view.

5. The illumination device according to claim 1, wherein
the scalene triangle, which is the cross-sectional shape of the first projecting portion, includes a first edge in contact with the first main surface of the first light guide, and a second edge and a third edge extending from the first edge,
the first edge and the second edge form a first angle, the first edge and the third edge form a second angle, and the second edge and the third edge form a third angle,
the scalene triangle, which is the cross-sectional shape of each of the third projecting portion, includes a fourth edge in contact with the third main surface of the second light guide, and a fifth edge and a sixth edge extending from the fourth edge,
the fourth edge and the fifth edge form a fourth angle, the fourth edge and the sixth edge form a fifth angle, and the fifth edge and the sixth edge form a sixth angle, and
the first angle and the fourth angle each are 90°.

6. The illumination device according to claim 5, wherein
the first edge, the second edge, and the third edge are different from each other in length, and
the fourth edge, the fifth edge, and the sixth edge are different from each other in length.

7. The illumination device according to claim 1, wherein
the second projecting portion and the fourth projecting portion each have a cross-sectional shape of an equilateral triangle.
